(19) United States
(12) Patent Application Publication
(10) Pub. No.: US 2025/0225828 A1
(43) Pub. Date: Jul. 10, 2025

(54) INTEGRATED SECURITY SYSTEM THAT INCLUDES SECURITY DEVICES AND AUTOMATED CONTROLLERS

(71) Applicant: Mobile Tech, Inc., Hillsboro, OR (US)

(72) Inventors: Sean Milstead, Hillsboro, OR (US); Robert Logan Blaser, Hillsboro, OR (US); Jacob Michael Collier, Hillsboro, OR (US)

(73) Assignee: Mobile Tech, Inc., Hillsboro, OR (US)

(21) Appl. No.: 19/011,056

(22) Filed: Jan. 6, 2025

Related U.S. Application Data
(60) Provisional application No. 63/618,840, filed on Jan. 8, 2024.

(51) Int. Cl. G07C 9/00

(52) U.S. Cl. CPC G07C 9/00182

(57) ABSTRACT

The current document is directed to improved, remotely controlled, and often internally powered security devices with enhanced features and capabilities as well as to integrated security systems that include the improved, remotely controlled, and often internally powered security devices. Enhanced security-device features include activation features incorporated into security devices that, upon receiving input from a user, awaken idling security devices and generate activation messages that are sent to one or more automated security-device controllers. The integrated security systems continuously, periodically, and/or intermittently collect information about the operational status of the security devices, continuously, periodically, and/or intermittently transmit information to security devices, and employ one or more automated controllers to provide a variety of security-system facilities and functions, through various different types of interfaces, to one another, to human users, and to third-party security systems.

### CROSS-REFERENCE TO RELATED APPLICATION

This application claims the benefit of Provisional Application No. 63/618,840, filed Jan. 8, 2024.

### TECHNICAL FIELD

The current document is directed to security systems, such as security systems used to secure products in retail environments and, in particular, to automated security systems that include remotely controlled and internally powered security devices, with activation features, that communicate with automated controllers.

### BACKGROUND

Security devices, including various types of locks, cables, and display pedestals, have been manufactured and used for thousands of years. With the advent of microprocessors, network communications, and other modern technologies, a new generation of security devices that incorporate these modern technologies has been developed to provide enhanced security features. New-generation security devices may be locked and unlocked by electrically powered motors and may be remotely controlled, through various types of communications media, including network communications and radio-frequency communications, to carry out a variety of operations. These new-generation security devices are being widely used in retail environments to secure displayed products and display cases. However, there are numerous problems and technical challenges associated with the use of new-generation security devices in retail environments, including overheads and difficulties associated with configuration, management, and interaction with retail personnel and other users in complex environments. For these reasons, designers, manufacturers, and users of new-generation security devices continue to seek improvements and enhanced features to facilitate use of new-generation security devices in retail environments and other environments secured by automated security systems.

### SUMMARY

The current document is directed to improved, remotely controlled, and often internally powered security devices with enhanced features and capabilities as well as to integrated security systems that include the improved, remotely controlled, and often internally powered security devices. Enhanced security-device features include activation features incorporated into security devices that, upon receiving input from a user, awaken idling security devices and generate activation messages that are sent to one or more automated security-device controllers. The integrated security systems continuously, periodically, and/or intermittently collect information about the operational status of the security devices, continuously, periodically, and/or intermittently transmit information to security devices, and employ one or more automated controllers to provide a variety of security-system facilities and functions, through various different types of interfaces, to one another, to human users, and to third-party security systems.

### BRIEF DESCRIPTION OF THE DRAWINGS

FIG. 1 illustrates an implementation of the currently disclosed automated security system within an environment secured by the automated security system.

FIG. 2 illustrates one type of security device that may be incorporated into the currently disclosed automated security system.

FIG. 3 illustrates an improved, remotely controlled, internally powered security device with enhanced features and capabilities.

FIG. 4 illustrates data stored within a representative improved security device, such as the security device shown in FIG. 3.

FIG. 5 provides a control-flow diagram for an event loop that lies at the foundation of the control logic that controls a security device.

FIG. 6 provides a control-flow diagram for the routine “handle activation” called in step 507 of FIG. 5.

FIG. 7 provides a control-flow diagram for the routine “receive commands and info” called in step 612 of FIG. 6.

FIG. 8 provides a control-flow diagram for the routine “execute command(s)” called in step 712 of FIG. 7.

FIG. 9 provides a control-flow diagram for the routine “asynchronous command execution,” called in step 828 of FIG. 8.

FIG. 10 provides a control-flow diagram for the routine “receive info” called in step 716 of FIG. 7.

FIGS. 11A-B provide a control-flow diagram for the routine “handle key card,” called in step 509 of FIG. 5.

FIG. 12 provides a control-flow diagram for the routine “handle sync,” called in step 511 of FIG. 5.

FIG. 13 provides a control-flow diagram for the routine “handle wake-up,” called in step 513 of FIG. 5.

FIG. 14 provides a control-flow diagram for the routine “handle internal event,” called in step 515 of FIG. 5.

FIG. 15 illustrates the local automated controller and the remote, higher-level automated controller.

FIG. 16 illustrates the data maintained by the local and remote automated controllers.

FIG. 17 provides a general architectural diagram for various types of computers.

FIG. 18 illustrates an Internet-connected distributed computing system.

FIG. 19 illustrates cloud computing.

FIG. 20 illustrates generalized hardware and software components of a general-purpose computer system, such as a general-purpose computer system having an architecture similar to that shown in FIG. 17.

FIGS. 21A-B illustrate two types of virtual machine and virtual-machine execution environments.

### DETAILED DESCRIPTION

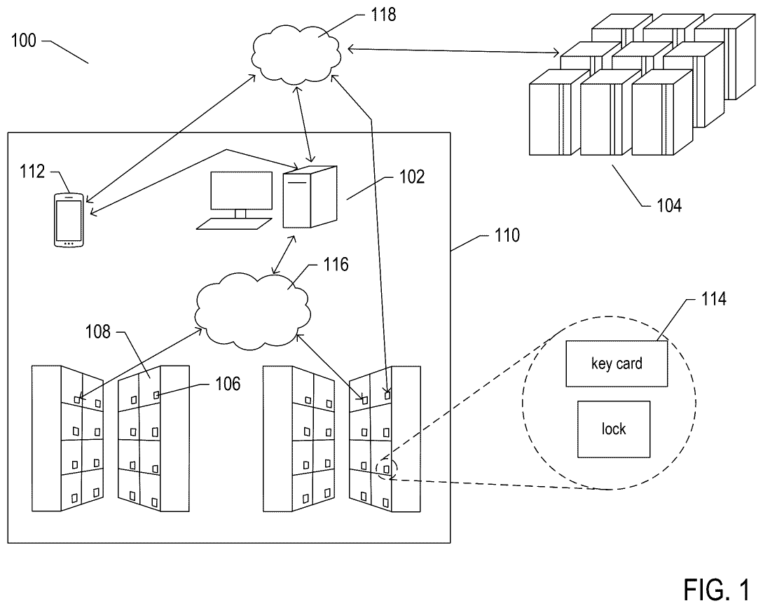

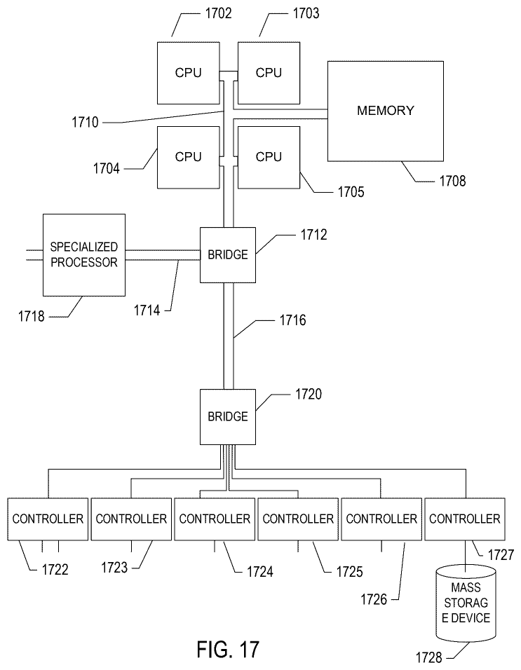

The current document discloses, in a first subsection below, automated security systems that include remotely controlled and internally powered security devices that communicate with automated controllers, with reference to FIGS. 1-16. In a following second subsection, an overview of computers and computer systems is provided with reference to FIGS. 17-21B.

### Automated Security Systems that Include Remotely Controlled and Internally Powered Security Devices that Communicate with Automated Controllers

FIG. 1 illustrates an implementation of the currently disclosed automated security system within an environment secured by the automated security system. In the illustrated implementation, the automated security system 100 includes a local automated controller 102, a remote, higher-level automated controller within a cloud-computing facility 104, and many security devices, including security device 106, each of which controls access to a product display, such as product display 108. In the illustrated implementation, a retail site 110 is secured via the security devices, local automated controller 102, higher-level automated controller 104, and additional user devices, including smart phones 112 and key cards 114. The local automated controller 102 interfaces to, and cooperates with, the remote, higher-level automated controller 104 to secure the retail site. Other local automated controllers, not shown in FIG. 1, interface to, and cooperate with, the remote, higher-level automated controller 104 to provide comprehensive, coordinated security to multiple different retail sites and other secured environments.

In the illustrated implementation, the security devices communicate with the local automated controller via a radio-frequency local network 116 and the local automated controller communicates with the remote, higher-level automated controller via a wide-area network 118, such as the Internet. In certain implementations, the security devices may instead directly communicate with the higher-level automated controller or may communicate both with the local automated controller and the higher-level automated controller. In the illustrated implementation, the security devices each control access to a display cabinet. These security devices may include various types of mechanical and electromechanical locks and/or latches along with one or more processors, electronic memories, stored processor instructions, and network-communications components. In alternative implementations, the retail site may be secured without the local automated controller communicating with the remote, higher-level automated controller. In yet additional alternative implementations, the retail site may be secured by cooperation between the remote, higher-level automated controller and the security devices, without the automated local controller acting as an intermediate.

Smart phones and key cards allow retail personnel and customers to access the automated security system in various ways. A retail employee may use a key card to stop a security device from continuing to sound an alarm or to unlock a security device, retail managers may access the security-system interfaces provided by one or both of the local automated controller and the remote, higher-level automated controller using a smart phone, and retail customers may directly request commands be directed to particular security devices using a smart phone, in certain implementations.

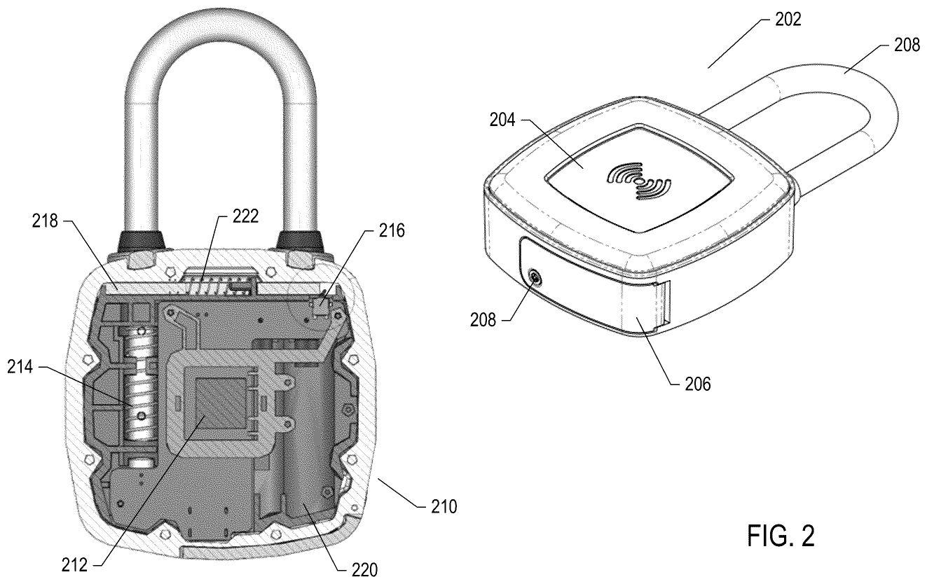

FIG. 2 illustrates one type of security device that may be incorporated into the currently disclosed automated security system. The security device 202 shown in FIG. 2 has the appearance of a standard padlock. However, it contains a radio-frequency-transparent faceplate 204 that allows it to communicate with the automated local controller via the local network as well as to receive radio-frequency signals from a key card. The security device 202 additionally includes a battery door 206 and a battery-door security fastener 208, the battery door providing access to an internal battery compartment in which a battery is mounted to power the security device. The shackle 208 is fully inserted into the security device, which is in a locked state.

When the security device senses the presence of a key card, receives information from the key card, such as a numerical identifier, and determines that the numerical identifier corresponds to a key card that is currently authorized for opening the security device, the security device emits a short sequence of audible signals, or beeps, and unlocks. Communication between the key card and the security device is implemented using one of a variety of different technologies, including radio-frequency-identification (“RFID”) technologies, Bluetooth technologies, and other such communications technologies.

Certain of the internal components of the security device 202 are shown in section 210. These include a microprocessor 212 that, along with a memory, implements the internal control logic of the security device, a spring 214 associated with the longer shackle arm that is compressed when the shackle arm is depressed into the locked position and decompresses to force the shackle arm upward during an unlocking operation, a switch 216, a latch plate 218, and a battery 220. When the latch plate is in a locked position, the switch is in an upward position. When the latch plate is translated to the right, the edge of the latch plate 218 depresses the switch 216 as it moves across the switch towards the right end of an internal surface. The switch emits a signal when the state of the switch changes from the upward position to a horizontal position and also emits a signal when the state of the switch changes from the horizontal position back to the upward position shown in FIG. 2. When the shackle has been cut by a thief, the thief needs to rotate the security device in order to provide a large enough opening for the shackle to be disengaged from a latch, cable, or chain. When the shackle arms are rotated, the rotation results in a translation force applied to the latch plate that moves the latch plate over the switch. Detection of a switch state change, from an up position to a horizontal position, when the security device is in the locked state results in the security device emitting one or more alarm signals. The alarm signals may include a loud audible alarm and, in certain implementations, may also include transmission of an alarm notification to a controller. A vertical motor shaft extends upward from an electric motor, not shown in FIG. 2, and is asymmetrically coupled to a cam. A horizontally mounted spring 222 is compressed when the latch plate is translated to the left by rotation of the cam, and the force produced when the spring decompresses translates the latch plate to the right when not prevented by the cam. The motor is controlled by control logic within the security device implemented by processor instructions executed by microprocessor 212. The security device receives commands from an automated controller, such as a command to activate the electric motor and rotate the cam in order to unlock the security device. The security device also reports various types of events to the automated controller, such as a change in the state of the switch 216 that indicates that the shackle has been cut or snapped.

There are many different types of sensors that may be used in an automated security device to detect the relative positions and orientations of components within the security device, various internal security-device states, and the position and orientation of the security device within its environment. These sensors may include mechanical sensors, such as switch 216 in the device shown in FIG. 2, but may also include electromechanical, electrical, electro-optical, optical, integrated-circuit-implemented sensors, and other types of sensors. For example, in alternative implementations, switch 216 may be replaced with a magnetic, electrical, or optical sensor that senses movement of the latch plate to the right to a position above the sensor.

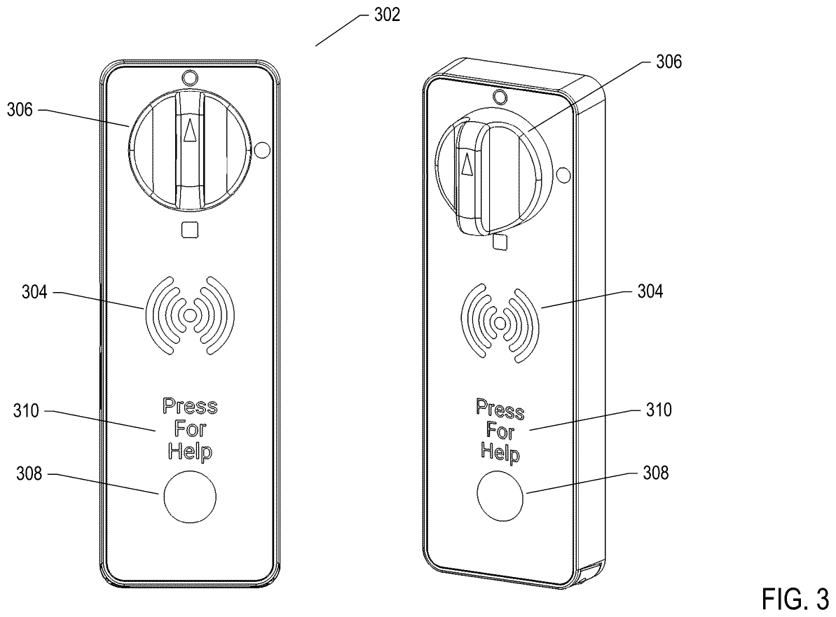

FIG. 3 illustrates an improved, remotely controlled, internally powered security device with enhanced features and capabilities. The security device 302 shown in FIG. 3 includes a radio-frequency-transparent face-plate area 304 and a knob 306 that can be turned to lock and unlock the security device. The security device may be mounted onto a product-display cover to secure the product-display cover to a product-display shelf or compartment when the security device is in a locked state. In addition, the improved security device includes a touch-sensitive activation button 308 that is labeled with an indication 310 that the touch-sensitive activation button can be pressed to call for assistance. As discussed further below, pressing the activation button by the user results in the internal logic of the security device being awakened from an idle state and transmission of an activation signal or message from the security device to one or both of the local and remote automated controllers. When the activation message is received by an automated controller, the automated controller can then undertake various types of actions, including sending one or more commands to the security device that directs the security device to collect authorizations, authorization credentials, and/or identifiers and to unlock itself when the automated controller has determined that access to whatever is secured by the security device should be granted. The activation feature may be a touch-sensitive button, a mechanical button, or any of many other types of features that can receive user input and generate an internal activation signal. The activation feature may also include an LED that illuminates when an input is made to the activation button.

Currently available new-generation security devices do not include activation features, such as touch-sensitive activation button 308 included in security device 302. Instead, customers in a retail environment may need to find and ask assistance from a clerk or retail employee to unlock a security device in order to access a product within a secured display area. In certain cases, various features and mechanisms for summoning assistance may be included within display counters or in other locations within the retail environment, but since these features and mechanisms are not physically contained within, or attached to, the security devices, the activation of such features and mechanisms cannot generally be directly associated, by an automated controller, with the specific lock and product-display area that the customer is seeking to access. In certain cases, an association between the security device and the product-display area may be stored manually or in an electronic memory to facilitate identifying, by an automated controller, the specific product-display area to which a customer is seeking access, but such indirect associations are also problematic, since the security devices may be moved from one product-display area to another and thus the manual or electronic associations between the security devices and product-display areas need to be reliably and timely updated. Including an activation button on or within a security device solves many of the problems associated with the current new-generation security devices that lack activation buttons.

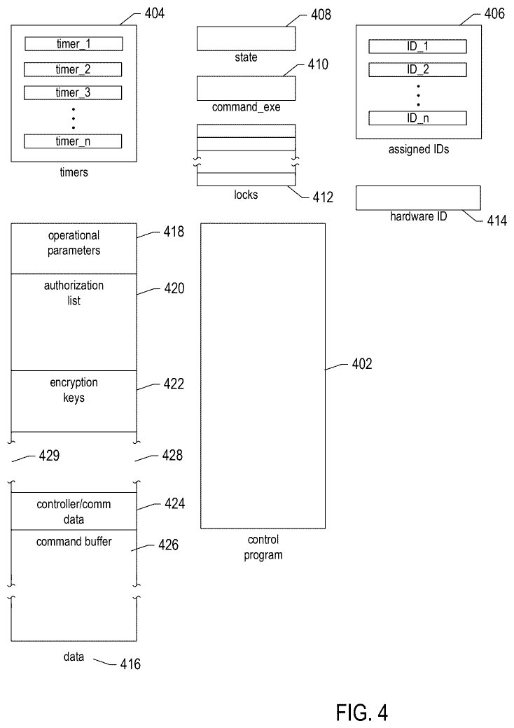

FIG. 4 illustrates data stored within a representative improved security device, such as the security device shown in FIG. 3. A large portion of the information stored within the device is the control program 402, comprising a large number of processor instructions. In addition, the security device stores a variety of different types of data. This includes data associated with one or more timers 404 that can be set to generate an interrupt following a period of time, a set of one or more numeric or alphanumeric identifiers assigned to the security device 406, a register or memory location storing an indication of the current state of the device 408, a second register, command_exec, further described below, the data components of one or more locks 412 that control access to stored data in memory, one or more hardware identifiers for the security device 414 that are stored in a non-volatile register or memory location when the security device is manufactured, and many different types of stored information, referred to as “data,” stored within an electronic memory 416, including the values for various operational parameters 418, a list of authorization credentials and/or identifiers for devices and users allowed to access the security device 420, one or more encryption keys 422 that are used for secure communications, controller and communications data, including network addresses 424, and a buffer containing commands received from an automated controller 426, referred to as the “command buffer.” Broken boundaries 428-429 indicate that many additional types of data may be stored in the security device. Operational parameters may include indications of time periods, such as a time that the security device can be in an unlocked state prior to generating an alarm, a period of time during which authorization credentials remain valid, indications of the types of authorization credentials that can be received and used by the security device, indications of commands that the security device is authorized to carry out on behalf of requesting controllers, and other such information. The authorization identifiers and credentials include radio-frequency identifiers (“RFIDs”), personal identification numbers (“PINs”), mobile-device identifiers, and many other types of identifiers and credentials. Additional data stored by the security device may include additional types of characterizations of the current operational state of the security device, such as the current battery level, may also include stored information about various internal events that have occurred, such as switch and button activations, authorization credentials received by the security device from key cards, and a log of the occurrences of various types of events

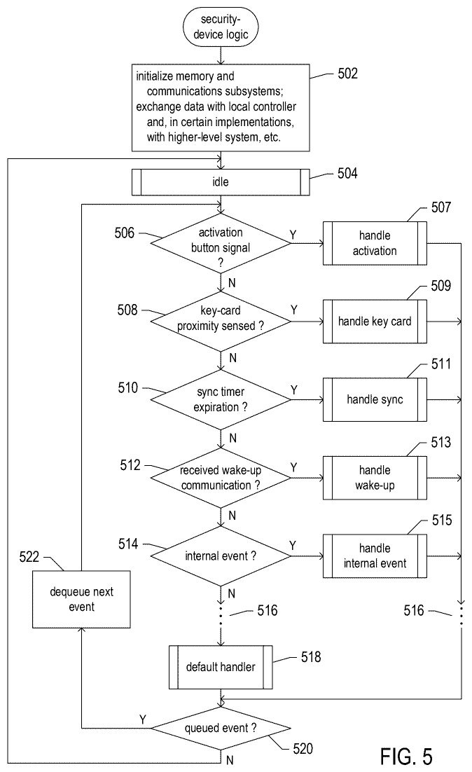

FIG. 5 provides a control-flow diagram for an event loop that lies at the foundation of the control logic that controls a security device. In step 502, various different initialization operations are carried out by the security device following power on. These include initialization of memory and communications subsystems, initial exchanges of data with an automated controller, internal tests and operational-state determination, and many other such initialization tasks. Any timers that need to be initially set are set during initialization, as are the values stored in certain global variables or registers. Following initialization, the security device enters an idle state via a call to a routine “idle,” in step 504. Battery-powered security devices, in particular, enter idle states in order to minimize energy expenditure during times when the security device is not actively carrying out operations or communicating with a controller. The security device is awakened from the idle state by various different types of events. In a series of conditional steps 506, 508, 510, 512, and 514, the security device determines the type of event that has awakened the security device and calls an appropriate handler routine to handle the event. For example, when an activation-button input signal has been received as a result of the activation button being touched or pushed, as detected in step 506, a handler “handle activation” is called, in step 507. When key-card proximity is detected, as determined in step 508, a handler “handle key card” is called, in step 509. When a sync timer has expired and generated an interrupt, as detected in step 510, the handler “handle sync” is called in step 511. When a communications message of some type has been received, as determined in step 512, a handler “handle wake-up” is called in step 513. When an internal event has been detected, as determined in step 514, a handler “handle internal event” is called, in step 515. Ellipses 516 indicate that there may be various other types of events that are detected and handled by the control logic of the security device. A default handler 518 is called to handle any rare and unexpected events. When one or more events have been queued for handling, as determined in step 520, a next event is dequeued, in step 522, and control flows back to step 506 to determine the type of event that has been dequeued and handle that event. Otherwise, control returns to step 504, resulting in the security device returning to an idle state.

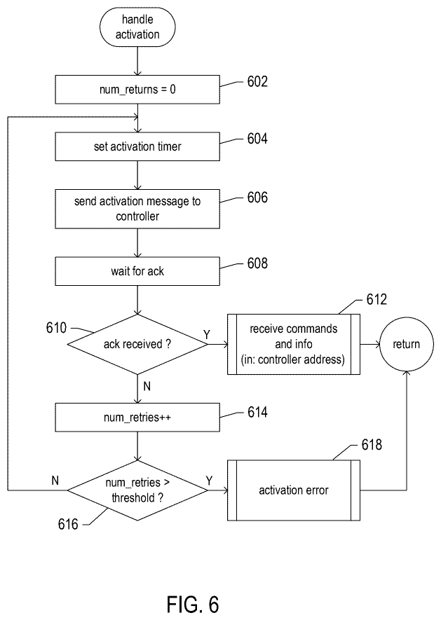

FIG. 6 provides a control-flow diagram for the routine “handle activation” called in step 507 of FIG. 5. In step 602, the routine “handle activation” sets a local variable num_replies to 0. In step 604, the routine “handle activation” sets an activation timer. In step 606, the routine “handle activation” sends an activation message to a controller. In certain implementations, the activation message is sent to the local automated controller, in other implementations the activation message is sent to the remote, higher-level controller, and in still other implementations, the activation message is sent to multiple controllers. In step 608, the routine “handle activation” waits to receive an acknowledgment from the controller to which the activation message was sent. When an acknowledgment message is received, as determined in step 610, a routine “receive commands and info” is called, in step 612. The routine “receive commands and info” requests commands from the automated controller that will be executed to attempt to authorize unlocking the security device and, when authorization is successful, to unlock the security device. In many implementations, the activation timer is deactivated prior to calling the routine “receive commands and info,” while, in other implementations, the activation timer is automatically deactivated when the activation handler calls the routine. Otherwise, when an acknowledgment message has not been received, as detected in step 610, the activation timer has expired, in which case the routine “handle activation,” in step 614, increments the value stored in the variable num_retries. When, as determined in step 616, the value stored in the variable num_retries is greater than a threshold value, an activation-error routine is called, in step 618. As with other such error routines mentioned below, the activation-error routine takes whatever steps are necessary to handle a detected error. In the current case, this may involve transmission of the activation message to a different controller or may involve various other operations carried out by the security device. When the value stored in the variable num_retries is less than or equal to the threshold value, control returns to step 604.

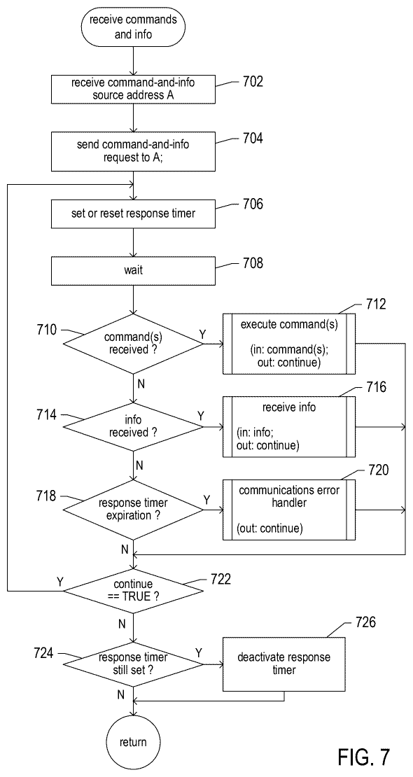

FIG. 7 provides a control-flow diagram for the routine “receive commands and info” called in step 612 of FIG. 6. The routine “receive commands and info” requests that a controller return the commands and information that have been queued for transmission to the security device by the same or a different controller. In step 702, the routine “receive commands and info” receives a source address A for the controller from which to request commands and other information. In step 704, the routine “receive commands and info” sends a request for commands and information to the received source address. In step 706, the routine “receive commands and info” sets a response timer after which, in step 708, the routine “receive commands and info” waits for the occurrence of an event. When the event that awakens the routine from the wait state is reception of a command(s) message, as determined in step 710, the routine “execute command(s)” is called in step 712. Otherwise, when the event represents the reception of an information message, as determined in step 714, the routine “receive info” is called in step 760. Otherwise, when the event represents expiration of the response timer, as determined in step 718, a communications-error handler is called, in step 720. All three of the routines called in steps 712, 716, and 720 return a Boolean value continue indicating whether or not the routine “receive commands and info” should continue operating. When the return value continue indicates continued operation, as determined in step 722, control returns to step 706. Otherwise, when the response timer is still set, as determined in step 724, the response timer is deactivated, in step 726.

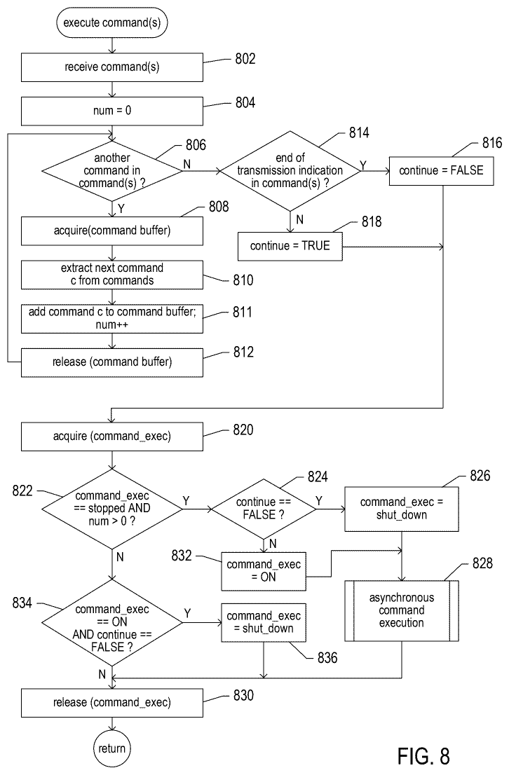

FIG. 8 provides a control-flow diagram for the routine “execute command(s)” called in step 712 of FIG. 7. In step 802, the routine “execute command(s)” receives a command(s) message. In step 804, the routine “execute command(s)” sets a local variable num to 0. When there is a next command in the command(s) message to process, as determined in step 806, the routine “execute command(s)” acquires a lock on the command buffer, in step 808, extracts the next command from the command buffer in step 810, adds the extracted command to the command buffer, in step 811, increments the value stored in local variable num, in step 811, and releases the lock on the command buffer in step 812. Control then flows back to step 806 where the routine “execute command(s)” attempts to extract another command from the command(s) message. When there are no further commands to extract from the command(s) message, as determined in step 806, and when the command(s) message contains an end-of-transmission indication, as determined in step 814, a local variable continue is set to FALSE, in step 816. Otherwise, the local variable continue is set to TRUE in step 818. Control then flows to step 820, where the routine “execute command(s)” acquires a lock on the register command_exec. When the command_exec register contains the value “stopped,” indicating that there is no currently executing asynchronous command-execution routine, and when the value stored in local variable num is greater than 0, as determined in step 822, then, when local variable continue contains the value FALSE, as determined in step 824, the routine “execute command(s)” sets the register command_exec to the value “shut_down,” in step 826, indicating that no further commands will be available for execution other than those already entered into the command buffer, and launches an asynchronous-command-execution routine, in step 828, after which control flows to step 830. Otherwise, when local variable continue contains the value TRUE, as determined in step 824, the routine “execute command(s)” sets the register command_exec to store the value “ON.” in step 832, before launching the asynchronous-command-execution routine in step 828. When the condition determined in step 822 is not true, then, when the command_exec register contains the value “ON,” indicating that an asynchronous-command-execution routine is currently executing, and when local variable continue contains the value FALSE, as determined in step 834, the routine “execute command(s)” sets the register command_exec to the value “shut_down,” in step 836, with control then flowing to step 830. In step 830, the routine “execute command(s)” releases the lock on the register command_exec before returning. Thus, the register command_exec contains one of three values: (1) “ON,” indicating that an asynchronous-command-execution routine is currently executing; (2) “shut_down,” indicating that the currently asynchronous-command-execution routine should terminate once it has executed all of the commands in the command buffer; and (3) “stopped,” indicating that there is no currently executing asynchronous-command-execution routine.

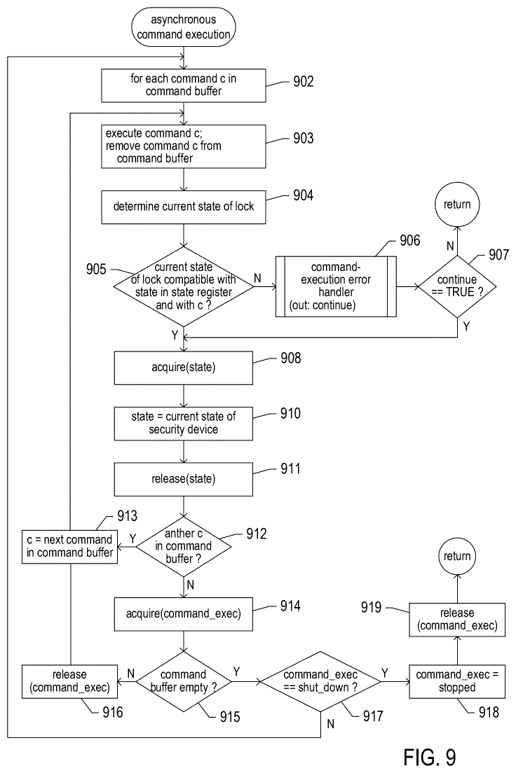

FIG. 9 provides a control-flow diagram for the routine “asynchronous command execution,” called in step 828 of FIG. 8. In the for-loop of steps 902-916, the routine “asynchronous command execution” considers each command c in the command buffer. In step 903, the routine “asynchronous command execution” executes the currently considered command c and removes the command c from the command buffer. In step 904, the routine “asynchronous command execution” determines the current state of the security device. When the current state of the security device is not compatible with the state indicated in the state register and with command c having been executed, as determined in step 905, a command-execution error handler is called in step 906 to remediate the detected error. The command-execution error handler returns an indication of whether or not the routine “asynchronous command execution” should continue. If not, as determined in step 907, the routine “asynchronous command execution” returns. Note that the command-execution error handler updates the command_exec register to contain the value “stopped.” Otherwise, execution continues at step 908, where the routine “asynchronous command execution” acquires a lock on the state register. In step 910, the routine “asynchronous command execution” sets the state register to the current state of the security device determined in step 904. Then, in step 911, the routine “asynchronous command execution” releases the lock on the state register. When there is another command in the command buffer to execute, as determined in step 912, the command is extracted from the command buffer, in step 913, following which control returns to step 903 to execute the next command. Otherwise, in step 914, the routine “asynchronous command execution” acquires a lock on the register command_exec. When the command buffer is not empty, as determined in step 915, the routine “asynchronous command execution” releases the lock on the register command_exec, in step 916, with control flowing to step 913. When the command buffer is empty, as determined in step 915, the routine “asynchronous command execution” determines whether the register command_exec contains the value “shut_down,” in step 917. If not, then flow returns to step 902 and the routine “asynchronous command execution” continues executing. Otherwise, the routine “asynchronous command execution” sets the value stored in register command_exec to “stopped,” in step 918, and releases the lock on register command_exec before returning. Thus, the routine “asynchronous command execution” executes all the commands stored in the command buffer and terminates when the register command_exec contains the value “shut_down.”

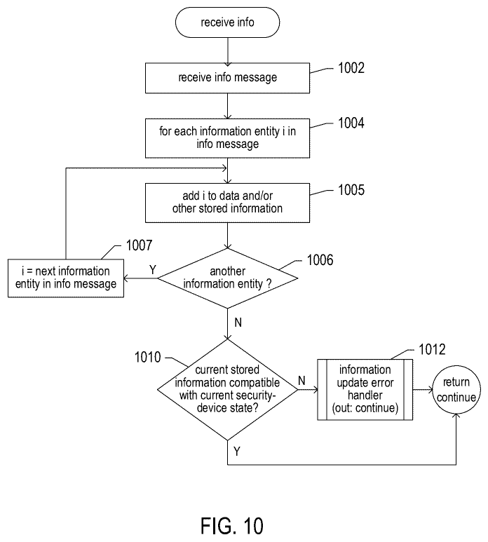

FIG. 10 provides a control-flow diagram for the routine “receive info” called in step 716 of FIG. 7. In step 1002, the routine “receive info” receives an information message. In the for-loop of steps 1004-1007, the routine “receive info” extracts each data entity from the information message and adds the extracted data entry to the data stored by the security device. Following completion of the for-loop of steps 1004-1007, the routine “receive info” determines, in step 1010, whether the stored information is compatible with the current state of the security device. If not, an information-update-error handler is called in step 1012.

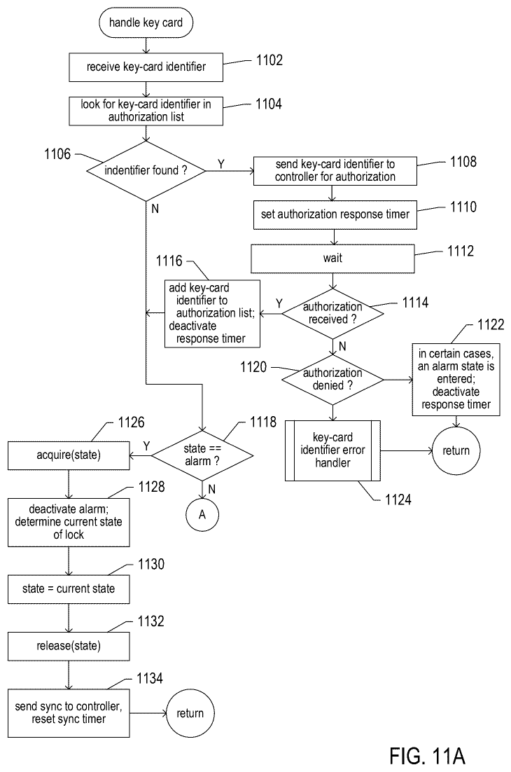

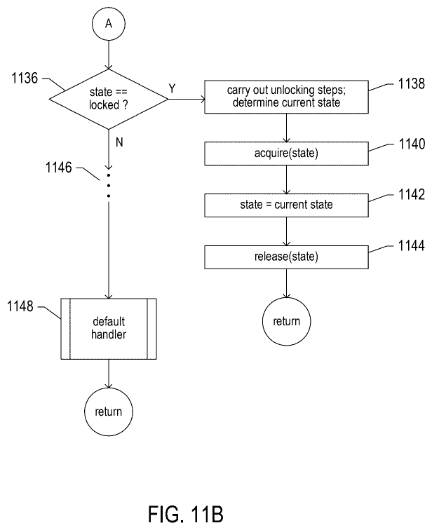

FIGS. 11A-B provide a control-flow diagram for the routine “handle key card,” called in step 509 of FIG. 5. In step 1102, the routine “handle key card” receives a key-card identifier. In step 1104, the routine “handle key card” determines whether the received key-card identifier is contained in the authorization list. When the identifier is not found in the authorization list, as determined in step 1106, the routine “handle key card” sends the key-card identifier to a controller for authorization, in step 1108, sets and authorization-response timer, in step 1110, and then waits, in step 1112. When authorization is received from the controller, in step 1114, the key-card identifier is added to the authorization list in step 1116 and control flows to step 1118. Otherwise, when the controller sends a message that denies authorization, as determined in step 1120, the security device may enter an alarm state, in certain implementations, in step 1122 before the routine “handle key card” returns. Note that the response timer is deactivated in both steps 1116 and 1122. When the wait, in step 1112, is terminated by expiration of the authorization-response timer, a key-card identifier error handler is called, in step 1124, after which the routine “handle key card” returns. In step 1118, the routine “handle key card” determines whether the current state of the security device is an alarm state. If so, then, in step 1126, the routine “handle key card” acquires a lock on the state register, deactivates the alarm and determines the current state of the security device, in step 1128, sets the state register to the determined current state, in step 1130, releases the lock on the state register, in step 1132, and, in step 1134, sends a sync message to the controller and restarts the sync timer before returning. Otherwise, when the current state of the security device is locked, as determined in his step 1136 of FIG. 11B, the routine “handle key card” carries out one or more unlocking steps and determines the current state of the security device, in step 1138, acquires a lock on the state register, in step 1140, sets the state register to an indication of the determined current state, in step 1142, and releases the lock, in step 1144, before returning. Ellipsis 1146 indicates that the routine “handle key card” may consider other possible states of the security device and carry out other corresponding operations. When no other explanation for the detected key-card proximity is determined, a default handler is called, in step 1148, following which the routine “handle key card” returns.

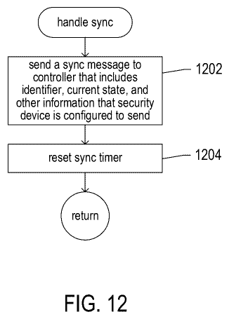

FIG. 12 provides a control-flow diagram for the routine “handle sync,” called in step 511 of FIG. 5. In step 1202, the routine “handle sync” prepares a sync message and transmits the sync message to one or more controllers. The sync message contains one or more identifiers for the security device, an indication of the current state of the security device, and any other information that the security device is configured to send to the controller. Then, in step 1204, the routine “handle sync” resets the sync timer. The sync messages periodically and/or intermittently provide information about the security device to one or more controllers so that the information related to the security device stored by the controllers is periodically and/or intermittently updated.

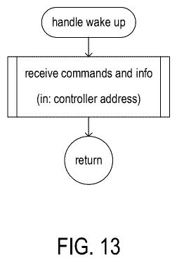

FIG. 13 provides a control-flow diagram for the routine “handle wake-up,” called in step 513 of FIG. 5. This routine calls the routine “receive commands and info” discussed above with reference to FIG. 7-10.

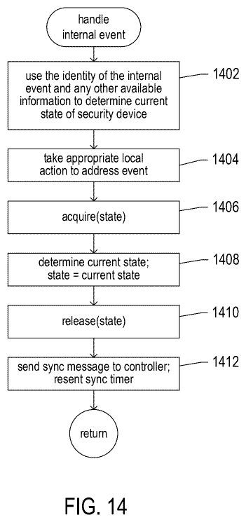

FIG. 14 provides a control-flow diagram for the routine “handle internal event,” called in step 515 of FIG. 5. In step 1402, the routine “handle internal event” uses the identity of the internal event, the occurrence of which resulted in the routine “handle internal event” being called, and any other available information, such as a sensor output or the state of a switch, to determine the current state of the security device. In step 1404, the routine “handle internal event” takes appropriate local actions to address the occurrence of the event. This may include transmitting one or more messages to one or more controllers, carrying out operations to place the security device in a desired security state, and other such actions. In step 1406, the routine “handle internal event” acquires a lock on the state register. In step 1408, the routine “handle internal event” determines the current state of the security device and sets the state register to contain an indication of the determined current state of the security device. In step 1410, the routine “handle internal event” releases the lock on the state register. Finally, in step 1412, the routine “handle internal event” prepares and sends a sync message to one or more controllers and then resets the sync timer before returning.

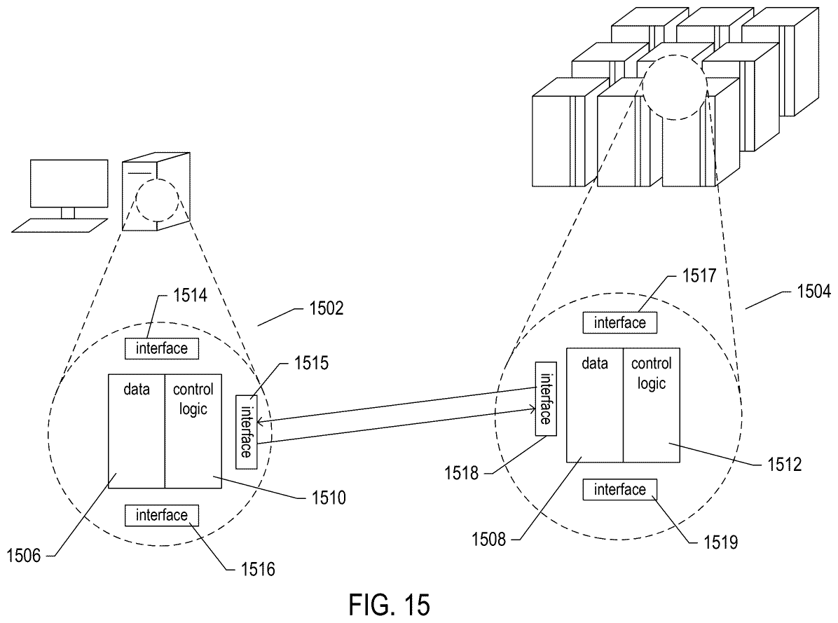

FIG. 15 illustrates the local automated controller and the remote, higher-level automated controller. Both automated controllers 1502 and 1504 can be considered to contain a large amount of data, 1506 and 1508, as well as a large set of processor instructions that represent the control logic for the controllers 1510 and 1512. Each controller provides one or more interfaces 1514-1519 for access by other controllers, third-party security systems, user applications running on smart phones, displayed user interfaces, and other entities, devices, and systems. Interfaces may be alert-generation interfaces, publish/subscribe interfaces such as Kafka, application programming interfaces (“APIs”), and protocol interfaces such as REST and SOAP. The interfaces provide access to many different types of operations and functionalities. Examples include interfaces that allow third-party security systems to access the data describing security devices and secure environments maintained by the local and remote automated controllers. Interfaces may also provide for input of operations and commands by human users as well as by third-party security systems that may be carried out, at least in part, by the automated controllers by directing commands and information to security devices that they control. The interfaces may allow users to specify authorization credentials, validate authorization credentials, activate key cards, deactivate key cards, monitor security devices for indications of problems and undesirable states, respond to activation signals by sending assistants to particular security devices and/or locations in secure environments, respond to activation signals and to other signals and occurrences by sending commands to security devices, activate various types of security systems in response to state changes in the security devices, and provide many additional types of functionalities and services.

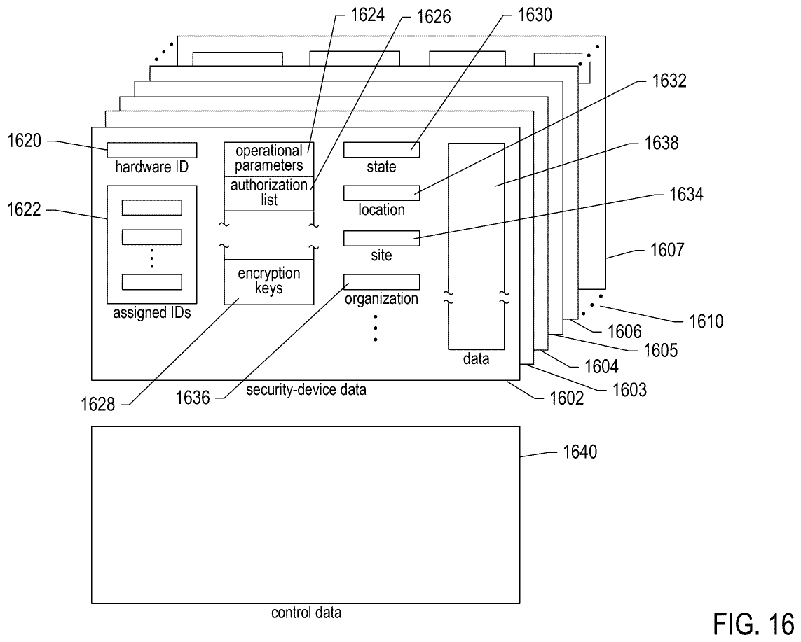

FIG. 16 illustrates the data maintained by the local and remote automated controllers. The data may be redundantly maintained by both controllers. Alternatively, only portions of the data may be redundantly maintained by both controllers, with other portions residing exclusively on either the local automated controller or the remote, higher-level automated controller. In certain implementations, there is only a single controller which maintains all of the data. The data maintained by the local and remote automated controllers includes security-device data for each security device that is monitored and maintained by the automated security system 1602-1607, with ellipsis 1610 indicating that there may be security-device data for a very large number of security devices. The information maintained for a particular security device may include the device's hardware ID 1620, the identifiers assigned to the device 1622, information that is also stored within the security device, such as operational parameters 1624, authorization credentials 1626, and encryption keys 1628, the current state of the security device 1630, the location of the security device within a secure environment 1632, a site identifier for the secure environment 1634, an indication of the organization to which the site belongs 1636, and many other types of additional information and data 1638 including event logs and additional indications of the current state of the security device. The automated controllers also store a large amount of additional data 1640, including, for example, maps of the secure environments, additional information about the secure environments, the organizations they belong to, various management and control policies specified by the organizations, and other such information. The information collected and maintained by the automated controllers provides the basis for the many different features and facilities provided by the automated controllers to the various interfaces discussed above with reference to FIG. 15. Much of this information is collected, maintained, and periodically and intermittently updated as a result of continuous communications between the automated controllers and the security device.

### Computer Hardware, Complex Computational Systems, and Virtualization

FIG. 17 provides a general architectural diagram for various types of computers, including computers that implement the currently disclosed security-system controllers. The computer system contains one or multiple central processing units (“CPUs”) 1702-1705, one or more electronic memories 1708 interconnected with the CPUs by a CPU/memory-subsystem bus 1710 or multiple busses, a first bridge 1712 that interconnects the CPU/memory-subsystem bus 1710 with additional busses 1714 and 1716, or other types of high-speed interconnection media, including multiple, high-speed serial interconnects. These busses or serial interconnections, in turn, connect the CPUs and memory with specialized processors, such as a graphics processor 1718, and with one or more additional bridges 1720, which are interconnected with high-speed serial links or with multiple controllers 1722-1727, such as controller 1727, that provide access to various different types of mass-storage devices 1728, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

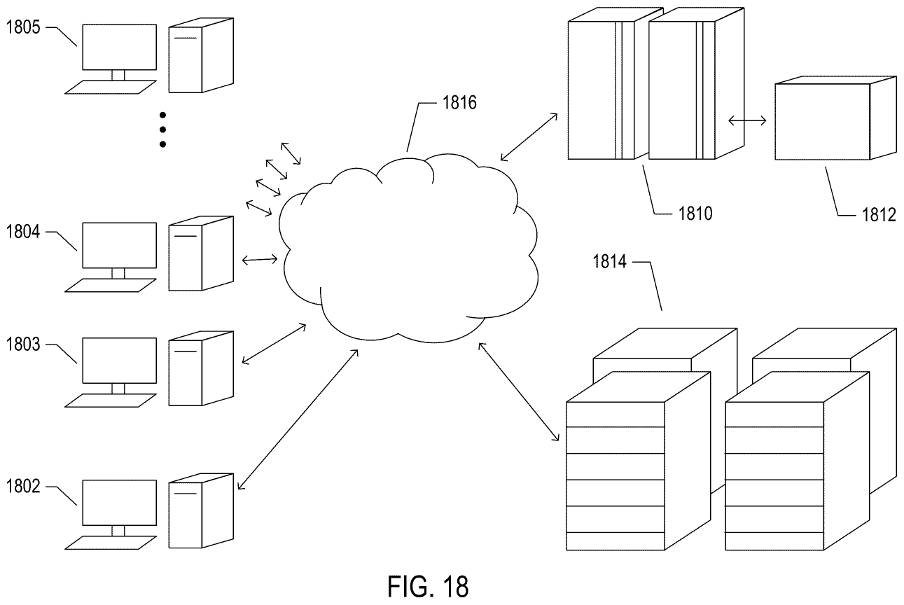

FIG. 18 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 18 shows a typical distributed system in which a large number of PCs 1802-1805, a high-end distributed mainframe system 1810 with a large data-storage system 1812, and a large computer center 1814 with large numbers of rack-mounted servers or blade servers all interconnected through various communications and networking systems that together comprise the Internet 1816. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

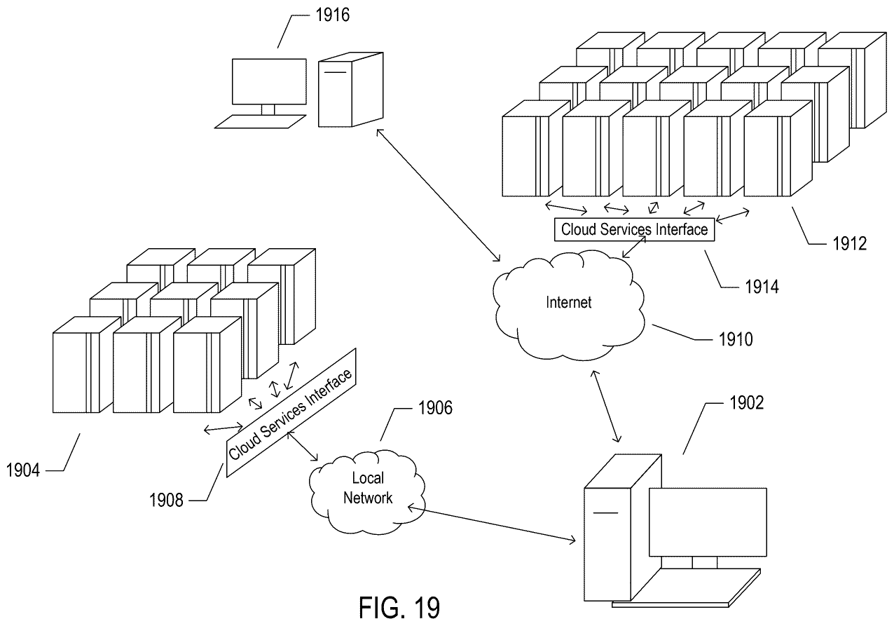

FIG. 19 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 19, a system administrator for an organization, using a PC 1902, accesses the organization's private cloud 1904 through a local network 1906 and private-cloud interface 1908 and also accesses, through the Internet 1910, a public cloud 1912 through a public-cloud services interface 1914. The administrator can, in either the case of the private cloud 1904 or public cloud 1912, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 1916.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

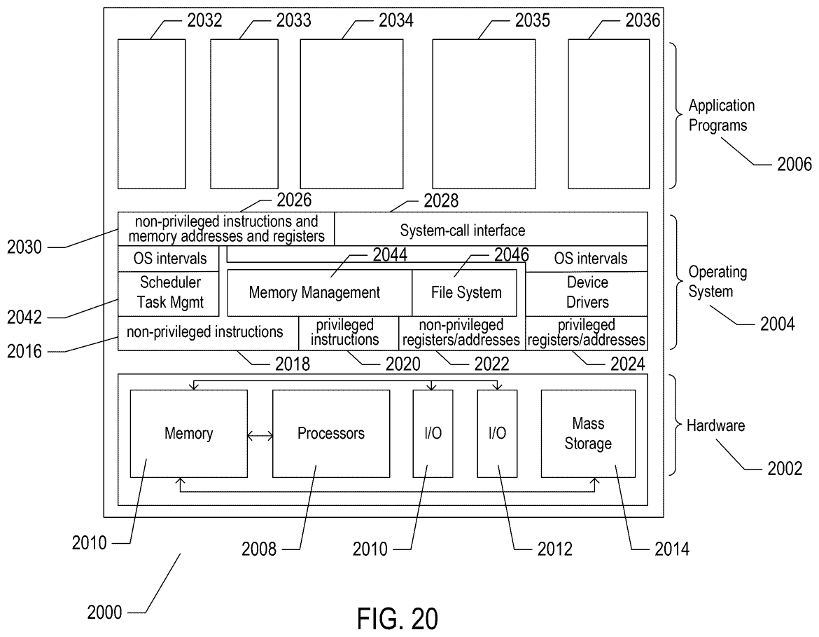

FIG. 20 illustrates generalized hardware and software components of a general-purpose computer system, such as a general-purpose computer system having an architecture similar to that shown in FIG. 1. The computer system 2000 is often considered to include three fundamental layers: (1) a hardware layer or level 2002; (2) an operating-system layer or level 2004; and (3) an application-program layer or level 2006. The hardware layer 2002 includes one or more processors 2008, system memory 2010, various different types of input-output (“I/O”) devices 2010 and 2012, and mass-storage devices 2014. Of course, the hardware level also includes many other components, including power supplies, internal communications links and busses, specialized integrated circuits, many different types of processor-controlled or microprocessor-controlled peripheral devices and controllers, and many other components. The operating system 2004 interfaces to the hardware level 2002 through a low-level operating system and hardware interface 2016 generally comprising a set of non-privileged computer instructions 2018, a set of privileged computer instructions 2020, a set of non-privileged registers and memory addresses 2022, and a set of privileged registers and memory addresses 2024. In general, the operating system exposes non-privileged instructions, non-privileged registers, and non-privileged memory addresses 2026 and a system-call interface 2028 as an operating-system interface 2030 to application programs 2032-2036 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 2042, memory management 2044, a file system 2046, device drivers 2048, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 2036 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted.

Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

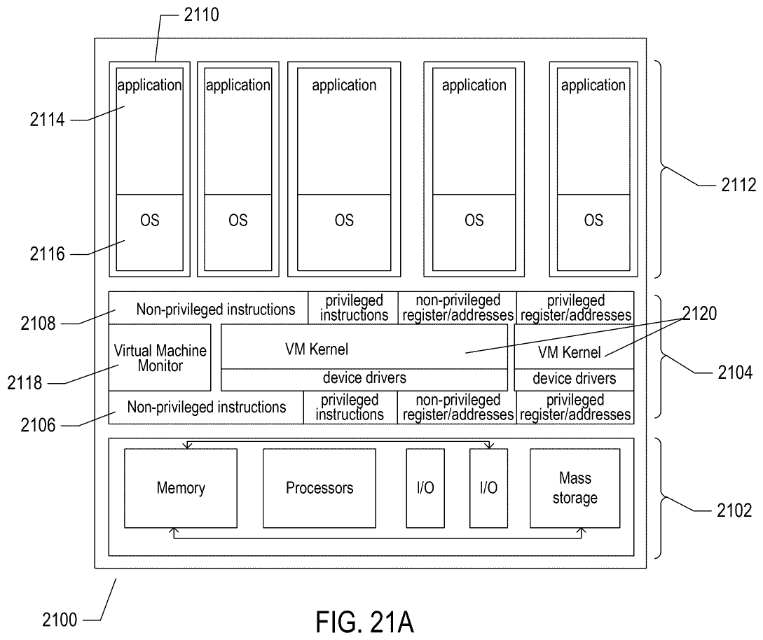

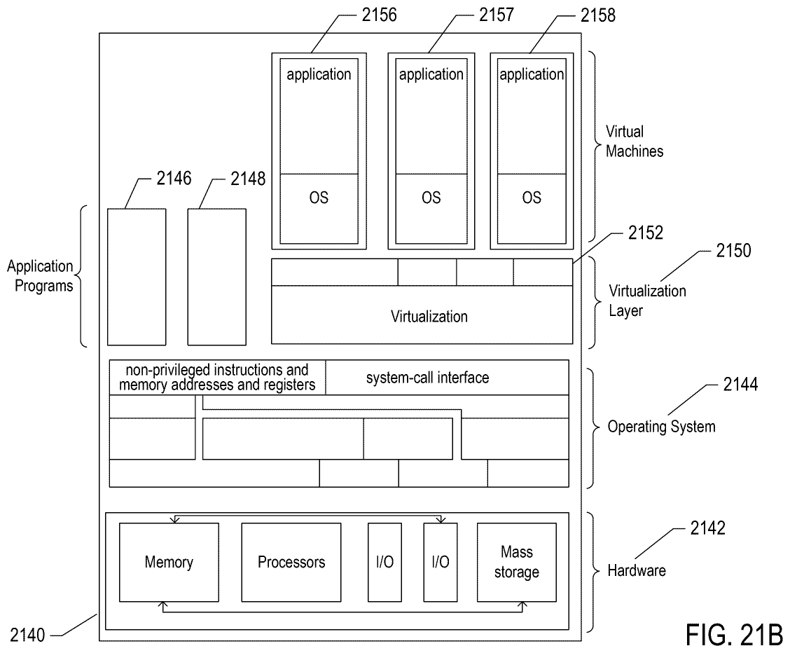

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 21A-D illustrate several types of virtual machine and virtual-machine execution environments. FIGS. 21A-B use the same illustration conventions as used in FIG. 20. FIG. 21A shows a first type of virtualization. The computer system 2100 in FIG. 21A includes the same hardware layer 2102 as the hardware layer 2002 shown in FIG. 20. However, rather than providing an operating system layer directly above the hardware layer, as in FIG. 20, the virtualized computing environment illustrated in FIG. 21A features a virtualization layer 2104 that interfaces through a virtualization-layer/hardware-layer interface 2106, equivalent to interface 2016 in FIG. 20, to the hardware. The virtualization layer provides a hardware-like interface 2108 to a number of virtual machines, such as virtual machine 2110, executing above the virtualization layer in a virtual-machine layer 2112. Each virtual machine includes one or more application programs or other higher-level computational entities packaged together with an operating system, referred to as a “guest operating system,” such as application 2114 and guest operating system 2116 packaged together within virtual machine 2110. Each virtual machine is thus equivalent to the operating-system layer 2004 and application-program layer 2006 in the general-purpose computer system shown in FIG. 20. Each guest operating system within a virtual machine interfaces to the virtualization-layer interface 2108 rather than to the actual hardware interface 2106. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 2108 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 2118 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 2108, the accesses result in execution of virtualization-layer code to simulate or emulate the privileged resources. The virtualization layer additionally includes a kernel module 2120 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 21B illustrates a second type of virtualization. In FIG. 21B, the computer system 2140 includes the same hardware layer 2142 and software layer 2144 as the hardware layer 402 shown in FIG. 4. Several application programs 2146 and 2148 are shown running in the execution environment provided by the operating system. In addition, a virtualization layer 2150 is also provided, in computer 2140, but, unlike the virtualization layer 2104 discussed with reference to FIG. 21A, virtualization layer 2150 is layered above the operating system 2144, referred to as the “host OS,” and uses the operating system interface to access operating-system-provided functionality as well as the hardware. The virtualization layer 2150 comprises primarily a VMM and a hardware-like interface 2152, similar to hardware-like interface 2108 in FIG. 21A. The virtualization-layer/hardware-layer interface 2152, equivalent to interface 416 in FIG. 4, provides an execution environment for a number of virtual machines 2156-2158, each including one or more application programs or other higher-level computational entities packaged together with a guest operating system.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. For example, security devices may push state and operational information to the automated controllers and/or the automated controllers may request that information rather than having information pushed to them. In certain implementations, commands and information are sent immediately to security devices by controllers rather than queued for periodic or intermittent delivery. There are many different possible security devices, from various types of mechanical locks and latches to tethers and pedestals for securing smart phones, monitoring devices and systems, machines, systems, vehicles, and other entities that exchange information with automated controllers and carry out commands on behalf of the automated controllers. Thus, the present disclosure is not intended to be limited to the embodiments shown herein but is to be accorded the widest scope consistent with the principles and novel features disclosed herein.

1. A security device that includes features and components that incorporate the security device into an automated security system, the security device securing one or more items in a retail environment, the security device comprising:
a mechanical or electromechanical lock;
a processor or microprocessor;
an electronic memory;
network-communications components and
a touch-sensitive activation button that, when pressed or touched, initiates transmission of an activation signal or message to an automated controller.

2. The automated security system of claim 1 wherein when the touch-sensitive activation button is pressed or touched, an LED or other illumination feature included in the security device is activated to produce light.

3. The security device of claim 1 wherein, upon receiving an activation signal or message, the automated controller sends one or more commands to the security device that are executed by the security device to attempt to authorize unlocking of the security device and, when authorization is successful, to unlock the security device.

4. The security device of claim 3 wherein the automated security system comprises:
one or more automated controllers that each
collects and maintains information about multiple security devices, and
transmits commands and information to the security devices; and
multiple security devices that each
receives commands and information from one or more of the one or more automated controllers, and
transmits state and operational information to one or more of the one or more automated controllers.

5. The security device of claim 4 wherein the one or more automated controllers include multiple local automated controllers, each located in an environment secured by the automated security system, and a remote, higher-level automated controller within a cloud-computing facility.

6. The security device of claim 5
wherein each security device communicates with a local automated controller via a radio-frequency local network; and
wherein each local automated controller communicates with the remote, higher-level automated controller via a wide-area network.

7. The security device of claim 6 wherein a security device additionally communicates directly with the remote, higher-level automated controller via a wide-area network.

8. The security device of claim 4
wherein each of the one or more automated controllers is a local automated controller located in an environment secured by the automated security system; and
wherein each security device communicates with a local automated controller via a radio-frequency local network.

9. The security device of claim 4
wherein each of the one or more automated controllers is a remote automated controller within a cloud-computing facility; and
wherein each security device communicates with a remote automated controller via a wide-area network.

10. The security device of claim 3 wherein the security device stores data in one or more electronic memories within the security device, the data including processor instructions that comprise a control program that, when executed by a processor or microprocessor within the security device, controls the security device to:
receive commands from one or more automated controllers and execute the received commands;
periodically send sync messages to the one or more automated controllers; and
detect and handle internal events.

11. The security device of claim 10 wherein the stored data further includes:
data associated with one or more timers that can be set to generate an interrupt following a period of time;
a set of one or more numeric or alphanumeric identifiers assigned to the security device; and
a register or memory location storing an indication of the current state of the device.

12. The security device of claim 11 wherein the stored data further includes:
one or more hardware identifiers for the security device that are stored in a non-volatile register or memory location when the security device is manufactured.

13. The security device of claim 11 wherein the stored data further includes:
the values for various operational parameters;
a list of authorization credentials and/or identifiers for devices and users allowed to access the security device;
one or more encryption keys that are used for secure communications;
controller and communications data, including network addresses; and
a buffer containing commands received from an automated controller.

14. The security device of claim 13 wherein the operational parameters include:
indications of time periods, such as a time that the security device can be in an unlocked state prior to generating an alarm;
a period of time during which authorization credentials remain valid;
the types of authorization credentials that can be received and used by the security device; and
the commands that the security device is authorized to carry out on behalf of requesting controllers.

15. The security device of claim 13 wherein the authorization credentials and/or identifiers include:
radio-frequency identifiers;
personal identification numbers; and
mobile-device identifiers.

16. The security device of claim 11 wherein the stored data further includes:
stored information that characterizes of the current operational state of the security device, including the current battery level;
stored information about various internal events that have occurred, including switch and button activations; and
authorization credentials received by the security device from key cards.

17. The security device of claim 10 wherein each security device additionally communicates with one or more smart phones and key cards.

18. The security device of claim 17 wherein the control program additionally controls the security device to:
sense and respond to key-card proximity; and
receive and respond to messages sent from a smart phone.

19. A method for securing one or more items in a retail environment, the method comprising:
incorporating into an automated security system one or more security devices, each security device securing one or more items in the retail environment, the security device comprising:
a mechanical or electromechanical lock,
a processor or microprocessor,
an electronic memory,
network-communications components, and
a touch-sensitive activation button that, when pressed or touched, initiates transmission of an activation signal or message to an automated controller.

20. The method of claim 19 wherein, upon receiving an activation signal or message, the automated controller sends one or more commands to the security device that are executed by the security device to attempt to authorize unlocking of the security device from which the activation signal or message was received and, when authorization is successful, to unlock the security device from which the activation signal or message was received.
